(19) United States
(12) Patent Application Publication
(10) Pub. No.: US 2004/0101749 A1
(43) Pub. Date: May 27, 2004

(54) Electrochemical cell with a single connector

(75) Inventors: Georges Caillon, Bruges (FR); Celine Lenhof, Le Bouscat (FR); Melanie Redois, Eysines (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/716,466

(22) Filed: Nov. 20, 2003

(30) Foreign Application Priority Data
Nov. 21, 2002 (FR) 02 14 570

(51) Int. Cl. H01M 2/26; H01M 2/02

(52) U.S. Cl. 429/181; 429/161; 429/176

(57) ABSTRACT

An electrochemical cell (1) comprises firstly a negative electrode (9) and a positive electrode (10), each comprising a current collector (11, 15) having a first portion (12, 16) defining a connection terminal (13, 18) extending from a second portion (14, 19) provided with an active material (15, 20), the connection terminals (13, 18) being placed on either side of an electrically insulating layer (22) and co-operating therewith to define a single connection tab (3), the cell also having a case (4) housing in leakproof manner the second portions (14, 19) of the current collectors (11, 15) while leaving at least a portion of the single connection tab (3) projecting outwards.

The invention relates to the field of electrochemical cells or batteries used for powering electronic components and/or circuits.

Numerous electronic components and/or circuits require a power source in order to perform at least one of the functions for which they are designed. For use in self-contained pieces of equipment of small dimensions, such as certain smart cards, the person skilled in the art has developed power sources of very small dimensions. Thus, extra-flat electrochemical cells or “batteries” have been proposed that are typically about 0.5 millimeters (mm) thick with length and width of the order of a few tens of millimeters.

In general, such cells comprise a sealed main portion housing in leaktight manner both a negative electrode and a positive electrode that are substantially parallel to each other and that are spaced apart from each other by a non-aqueous electrolyte. The electrodes are connected to respective spaced-apart negative and positive connection terminals that project from the main portion either on the same side as is-the case for patent document EP-0 852 404, or from opposite sides as is the case for the product sold under the registered trademark “LITE*STAR”.

That physical separation between the positive and negative connection terminals does indeed serve to limit the risks of a short circuit, however it presents the following drawbacks:

1) it makes the manufacturing method more complex;

2) it imposes severe alignment constraints;

3) it makes each of the connection terminals vulnerable;

4) it increases the overall dimensions of the battery; and

5) it is harmful in terms of sealing quality.

In addition, some of those drawbacks are made worse when the battery needs to be flexible, as is the case in particular for batteries fitted to smart cards.

The invention thus seeks to remedy the above-described drawbacks in full or in part.

To this end, the invention provides an electrochemical cell comprising firstly a negative electrode and a positive electrode, each comprising a current collector covered in an active material and provided with an extension defining a connection terminal, and secondly packaging means housing said electrodes in leaktight manner. According to the invention, the connection terminals are placed on either side of an electrically insulating layer and co-operate therewith to define a single connection tab, which passes through said packaging means in such a manner as to project outwards, at least in part.

Each electrode has a current collector comprising a first portion defining a connection terminal that is extended by a second portion provided with an active material, the connection terminals being placed on either side of an electrically insulating layer in order to constitute a single connection tab. As a result, both connection terminals are mounted on a single support while remaining completely insulated electrically, and their strength is greatly reinforced. In addition, this makes it possible to reduce significantly the overall size of the electrochemical cell, while also improving its leakproofing. In addition, this makes it possible to simplify the method of manufacturing the electrochemical cell and it relaxes alignment constraints. Finally, this facilitates operations of connecting the electrochemical cell to the electronic component(s) and/or circuit(s) it is to power.

Preferably, in order to reinforce the insulation between the connection terminals, an auxiliary layer of insulation is interposed between said packaging means and the connection tab. By way of example, such an auxiliary layer may be made of a material constituted by at least one polymer selected from an acrylic or maleic polymer and a polyolefin such as, in particular, a homopolymer of ethylene or of propylene, a copolymer of ethylene and propylene, or a mixture thereof.

Furthermore, the electrically insulating layer may optionally be constituted by two sublayers and it is preferably made of a material constituted by at least one polymer selected from an acrylic or maleic polymer and a polyolefin, such as, in particular, a homopolymer of ethylene or of propylene, a copolymer of ethylene and propylene, or a mixture thereof.

Also preferably, the packaging means (or case) is constituted by a multilayer structure having at least a support layer, e.g. of aluminum, provided with a first face secured to an outer protective layer, e.g. made of a material of the acrylic varnish or polyethylene terephthalate (PET) type. This multilayer structure may also have an inner layer secured to a second face of the support layer, and for example made of a material constituted by at least one polymer selected from a polyolefin such as, in particular, a homopolymer of ethylene or of propylene, a copolymer of ethylene and propylene, or a mixture thereof, or even an acrylic polymer.

The packaging means may optionally be flexible so that the electrochemical cell can be implanted in a piece of equipment that is likely to be subjected to stresses such as two-dimensional bending or twisting.

According to another characteristic of the invention, each second portion is secured to an active material suitable for being impregnated by a non-aqueous electrolyte carried, for example, by a membrane housed in the case.

The invention also provides a battery including at least one electrochemical cell of the type described above.

The invention is particularly well suited to powering electronic component(s) and/or circuit(s), particularly when implanted in a smart card.

Other characteristics and advantages of the invention appear on examining the following detailed description and the accompanying drawing, in which:

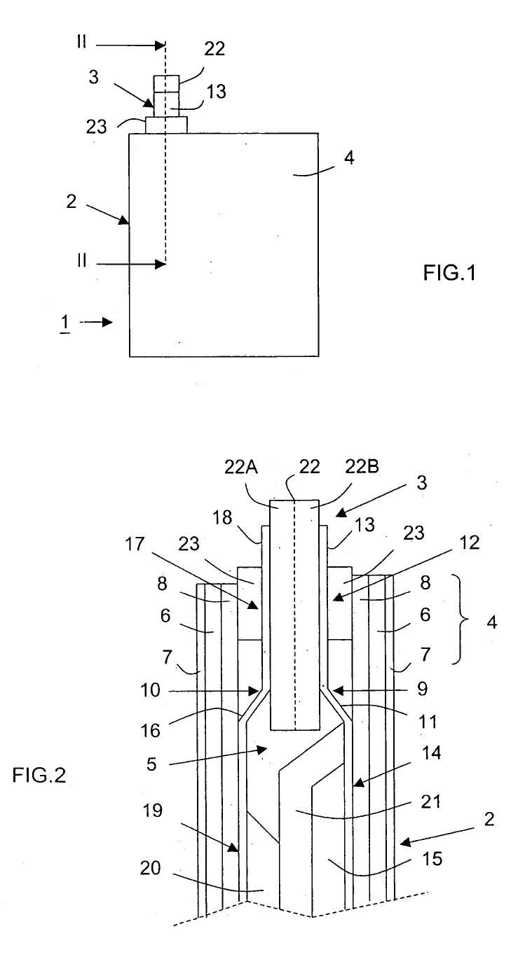

FIG. 1 is a diagrammatic side view of an embodiment of a battery of the invention; and

FIG. 2 is a cross-section view on line II-II of FIG. 1.

The accompanying drawings may serve not only to add to the description of the invention, but they may also contribute to defining it, where appropriate.

FIGS. 1 and 2 show an embodiment of a battery 1 fitted with a single electrochemical cell of the invention. Consequently, in the description below, the battery 1 is taken to be the same as the electrochemical cell. However, the battery 1 could naturally comprise a plurality of electrochemical cells connected in series or in parallel.

In the example shown in FIG. 1, the battery 1 presents a main portion 2 of rectangular shape suitable for being integrated in a piece of equipment of the smart card type, and from which there projects a single connection tab 3. By way of example, the length, width, and thickness of the main portion 2 are respectively about 35 mm, 20 mm, and 0.5 mm. However the main portion 2 may take numerous other shapes and dimensions depending on where the battery 1 is to be implanted.

As can be seen more clearly in FIG. 2, the main portion 2 of the battery 1 includes packaging means 4 which constitute a case defining an inside space 5. This case 4 is preferably made in the form of a multilayer structure including at least one support layer 6 having a first face (the outer face) secured to an outer protective layer 7.

By way of example, the support layer 6 is made of aluminum foil and the outer layer 7 is made of acrylic varnish or of polyethylene terephthalate (PET).

As shown, the case 4 may also include an inner layer 8 secured to a second face (the inner face) of the support layer 6. This inner layer 8 is constituted, for example, by a material which is constituted by at least one polymer selected from a polyolefin such as, in particular, a homopolymer of ethylene or of propylene, a copolymer of ethylene and propylene, or a mixture thereof, or even an acrylic polymer. It may be constituted in particular by polypropylene, polyethylene, or a copolymer of ethylene and propylene.

The above-specified materials constituting the case 4 are adapted to uses for the battery 1 which require it to be flexible. Consequently, they are not limiting in any way, and they could be made in completely different manner, depending on requirements.

The inside space 5 defined by the case 4 houses firstly a portion of a negative electrode 9 and a portion of a positive electrode 10. The negative electrode 9 is constituted by a metal plate 11 defining a current collector, the plate having a first portion 12 defining a connection terminal 13 and extending from a second portion 14 which is secured to an active material 15. By way of example, the metal plate 11 is made of copper.

Similarly, the positive electrode 10 is constituted by a metal plate. 16 defining a current collector having a first portion 17 defining a connection terminal 18 and extending from a second portion 19 that is secured to an active material 20. By way of example, the metal plate 16 is made of aluminum.

In a secondary (or rechargeable) lithium cell, the active material 15 housed in the internal portion 5 of the case 4 and secured to the second portion 14 of the negative electrode 9 is constituted, for example, by a paste containing a carbon compound suitable for lithium atom insertion, e.g. LiC₆, and the active material 20 housed in the internal portion 5 of the case 4 and secured to the second portion 19 of the positive electrode 10 is a paste containing a metal oxide including lithium atoms, such as LiCoO₂.

In its inside portion 5, the case 4 also houses a membrane 21 separating the active materials 15 and 20 and placed in contact with them in such a manner as to supply them with electrolyte. In the present example of a lithium cell, the membrane 21 is provided with an electrolyte constituted by a lithium salt such as LiPF₆ in solution in an organic solvent.

Instead of making a non-aqueous secondary (or rechargeable) electrochemical cell of the lithium ion type (Li-ion), it is also possible to make a non-aqueous primary electrochemical cell of the metallic lithium type.

The electrochemical cell 1 also has an electrical insulating layer 22 having two outside faces which are substantially parallel in this case, and secured respectively to the first portions 12 and 17 of the negative and positive electrodes 9 and 10 which define the negative and positive connection terminals 13 and 18.

As represented in FIG. 2 by a dashed line, the layer of insulation 22 may optionally be constituted by two sublayers 22A and 22B.

By way of example, the insulating layer 22 (or the sublayers 22A and 22B) is/are made of a material constituted by at least one polymer selected from an acrylic or maleic polymer and a polyolefin such as, in particular, a homopolymer of ethylene or of propylene, a copolymer of ethylene and propylene, or a mixture thereof. It may be constituted, in particular by polypropylene, polyethylene, or a copolymer of ethylene and propylene modified by grafting carboxylic functions.

The connection terminals 13 and 18 thus placed on either side of the electrically insulating layer 22 co-operate therewith to define a single connection tab 3. A “bottom” portion of this connection tab 3 is received in the inside portion 5 of the case 4, while a “top” portion of said connection tab projects from said face 4 so as to enable a connection to be made between the two connection terminals 13 and 18 and electronic components and/or circuits implanted in a piece of equipment.

This single terminal structure makes both connection terminals significantly stronger and enables the method of manufacturing the electrochemical cell of the invention to be significantly simplified, while also reducing constraints concerning connection terminal alignment. In addition, the fact of there being only one passage through the case 4, unlike the two passages in prior art cells, significantly improves the sealing of the inside of the case.

In the example shown in FIG. 1, the connection tab 3 is small in the lateral direction (defined by the direction perpendicular to the axis II-II) compared with the central portion 2. In other words, the fraction of the first portion 12 or 17 that defines a connection terminal 13 or 18 is cut out from a larger sheet. However, the configuration could be different should that be necessary. In this example, the connection terminals 13 and 18 do not project beyond the insulating layer 22. Nevertheless, at least one of the connection terminals 13 and 18 could overlap the layer of insulation 22 locally to a very small extent. In addition, in this example, the connection terminals 13 and 18 are of the same longitudinal extent (defined by the direction parallel to the axis II-II). However that could be different if so required.

In order to improve the electrical insulation and the protection of the connection terminals 13 and 18 while also improving sealing where the passages made through the case 4, it is also possible to provide one or two auxiliary insulating layers 33 interposed between the case and the connection tab 3. A single auxiliary layer 23 can suffice, providing it is electrically insulating. In which case it may be formed as a sleeve completely surrounding the connection tab 3 where it passes through the case. When two auxiliary layers are used, it is no longer essential, although it remains preferable, for them to be electrically insulating. Under such circumstances, they may be in the form of rectangular parallelepipeds or “patches”.

For example, the insulating auxiliary layer 23 (or the two layers) is/are made of an adhesive material constituted by at least one polymer selected from an acrylic or italeic polymer and a polyolefin such as, in particular, a homopolymer of ethylene or of propylene, a copolymer of ethylene and propylene, or a mixture thereof. It may be constituted in particular by polypropylene, polyethylene, or a copolymer of ethylene and propylene modified by grafting carboxylic functions.

Because the two connection terminals are superposed with an insulating material interposed between them, it is possible greatly to reduce the number of connection terminals that are broken during manufacture and testing, typically by a factor of ten. This results mainly from the fact that because of the invention, the compression forces and above all the twisting forces to which the superposed connection tabs are subjected are greatly reduced.

In addition, the quality of sealing can be greatly improved. It has been found that water penetrates about 50% more slowly into the electrochemical cell, thus making it possible to envisage a significant increase in its lifetime under normal conditions of use, in particular by a factor approaching two.

Furthermore, since there is only one zone through current flows, instead of two, it is possible to simplify inspection of the difficult operation of sealing the place where the connections pass through the case.

The invention is not limited to the embodiments of an electrochemical cell and battery as described above merely by way of example, but it covers any variant that the person skilled in the art can envisage in the ambit of the following claims.

Thus, the description relates to a secondary (or rechargeable) type electrochemical cell, e.g. a non-aqueous cell (Li-ion). However, the invention is not limited to this type of electrochemical cell. In particular it can apply to any other type of secondary electrochemical cell having a non-aqueous electrolyte and preferably operating without internal pressure, or it can even relate to a primary electrochemical cell (such as a lithium primary cell, for example).

Furthermore, the electrochemical cell described is rectangular in shape and small in thickness. However, the invention is not limited to this particular configuration for an electrochemical cell.

In addition, a battery is described above that comprises a single electrochemical cell. However a battery of the invention is not limited to this particular circumstance.

What is claimed is:

1. An electrochemical cell comprising i) a negative electrode and a positive electrode, each comprising a current collector covered in an active material and provided with an extension defining a connection terminal, and ii) packaging means housing said electrodes in leaktight manner, the cell being characterized in that said connection terminals are placed on either side of an electrically insulating layer and co-operate therewith to define a single connection tab, and in that said single connection tab passes through said packaging means in such a manner as to project outwards, at least in part.

2. A cell according to claim 1, characterized in that it includes an insulating auxiliary layer place between said packaging means and said connection tab.

3. A cell according to claim 2, characterized in that said insulating auxiliary layer is constituted by a material comprising at least one polymer selected from acrylic polymer, a maleic polymer, and a polyolefin, and in particular a homopolymer of ethylene, and/or a homopolymer of propylene, and/or a copolymer of ethylene and propylene, or a mixture thereof.

4. A cell according to claim 1, characterized in that said electrically insulating layer is constituted by two sublayers.

5. A cell according to claim 1, characterized in that said electrically insulating layer is constituted by a material comprising at least one polymer selected from an acrylic polymer, a maleic polymer, and a polyolefin, and in particular a homopolymer of ethylene, and/or a homopolymer of propylene, and/or a copolymer of ethylene and propylene, or a mixture thereof.

6. A cell according to claim 1, characterized in that said packaging means are constituted by a multilayer structure comprising at least one support layer provided with a first face secured to an outer protective layer.

7. A cell according to claim 6, characterized in that said support layer is made of aluminum.

8. A cell according to claim 6, characterized in that said outer layer is made of a material selected from a group comprising at least a protective varnish and a layer of polyethylene terephthalate (PET).

9. A cell according to claim 6, characterized in that said multilayer structure includes an inner layer secured to a second face of the support layer.

10. A cell according to claim 9, characterized in that said inner layer is made of a material comprising at least one polymer selected from an acrylic polymer, and a polyolefin, and in particular a homopolymer of ethylene, and/or a homopolymer of propylene, and/or a copolymer of ethylene and propylene, or a mixture thereof.

11. A cell according to claim 1,-characterized in that said packaging means are flexible.

12. A cell according to claim 1, characterized in that each second portion is secured to an active material suitable for being impregnated with a non-aqueous electrolyte.

13. A cell according to claim 12, characterized in that it includes a membrane housed in said packaging means, in contact with each of the active materials, and including said non-aqueous electrolyte.

14. A cell according to claim 1, characterized in that it is of the rechargeable type.

15. A battery, characterized in that it comprises at least one electrochemical cell according to claim 1.

16. Electronic components and/or circuits powered by an electrochemical cell according to claim 1 and/or a battery according to claim 15.

17. Electronic components and/or circuits according to claim 16, implanted in a smart card.
